(19) United States
(12) Patent Application Publication
(10) Pub. No.: US 2020/0350774 A1
(43) Pub. Date: Nov. 5, 2020

(54) SUPPLEMENTAL CHARGER

(71) Applicant: LiBEST INC., Daejeon (KR)

(72) Inventors: Joo Seong KIM, Daejeon (KR); Jin Hong HA, Daejeon (KR); Kwang Seok KIM, Chungcheongnam-do (KR); Mi Hee KIM, Gyeonggi-do (KR); Gil Ju LEE, Daejeon (KR); Sang Yoon KIM, Daejeon (KR); Keum Bong HAN, Gwangju (KR)

(21) Appl. No.: 16/930,908

(22) Filed: Jul. 16, 2020

Related U.S. Application Data
(63) Continuation of application No. PCT/KR2019/000609, filed on Jan. 15, 2019.

(30) Foreign Application Priority Data
Jan. 19, 2018 (KR) 10-2018-0007248

(51) Int. Cl. H02J 7/00; H02J 7/02; H02J 7/34; G06F 1/16

(52) U.S. Cl. CPC H02J 7/0042; H02J 7/02; G06F 1/1635; G06F 1/163; H02J 7/342

(57) ABSTRACT

A supplemental charger capable of being combined with a wearable device includes a main body including a strap having opposing ends that are extendable in opposite directions and connectable to each other, coupling parts configured to couple the wearable device to the main body, wherein at least one coupling part is attached to a respective one of the opposing ends of the strap; and a charging unit to charge the wearable device when the wearable device is coupled to the main body.

### TECHNICAL FIELD

The present disclosure relates to a supplemental charger that may be combined with a wearable device and a method of charging the wearable device through the supplemental charger.

### BACKGROUND

In recent years, various kinds of wearable devices such as smart watches, smart bands, smart necklaces, etc. have been developed and marketed by entities including, as examples only, Apple®, FitBit®, Garmin®, etc. These wearable devices perform various functions such as facilitating phone calls, monitoring a user's cardiovascular activity, providing date and time, text messaging, providing a user's appointment calendar, etc., and the scope of functions of the wearable devices is increasing.

These wearable devices may be powered by a built-in battery. However, because these wearable devices are worn on the body of a user and thus limited in size, weight, etc., it is difficult to increase the capacity of the battery without unduly increasing the size, weight, etc.

Meanwhile, a separate external charging device is needed thus prohibiting the user from wearing the wearable device while charging the battery.

### SUMMARY

The present disclosure pertains to a supplemental charger that can be coupled to, combined with, or otherwise attached to a wearable device, and can charge the wearable device while a user wears the wearable device. The problems to be solved by the present disclosure are not limited to the above-described problems. There may be other problems to be solved by the present disclosure.

According to an exemplary embodiment, a supplemental charger capable of being coupled to, combined with, or otherwise attached to a wearable device, may include a main body including a strap having opposing ends that are extendable in opposite directions and connectable to each other, coupling parts configured to couple the wearable device to the main body, wherein at least one coupling part is attached to a respective one of the opposing ends of the strap; and a charging unit to charge the wearable device when the wearable device is coupled to the main body.

According to the exemplary embodiment, wherein the main body includes a strap that may be wound around a wrist of a user of the wearable device.

According to the exemplary embodiment, wherein the coupling parts are configured to facilitate attachment and detachment of the wearable device.

According to the exemplary embodiment, wherein the coupling parts include a first coupling part and a second coupling part that are disposed separately on a top surface of the main body.

According to the exemplary embodiment, wherein the first coupling part connects to a first side of the wearable device to fix the first side of the wearable device to the main body, and the second coupling part connects to a second side of the wearable device to fix the second side of the wearable device to the main body.

According to the exemplary embodiment, wherein the first coupling part connects magnetically to the first side of the wearable device or slides onto the first side of the wearable device, and the second coupling part connects magnetically to the second side of the wearable device or slides onto the second side of the wearable device.

According to the exemplary embodiment, wherein the charging unit includes a charging area on a top surface of the main body, on in which the wearable device is coupled to the main body.

According to the exemplary embodiment, wherein the charging area faces a sensor on a bottom surface of the wearable device coupled to the main body.

According to the exemplary embodiment, wherein the charging unit charges the wearable device coupled to the main body at the charging area.

According to the exemplary embodiment, wherein the battery is disposed on an opposite side of the main body, relative to the charging area, integrated on to a bottom surface of the main body.

According to the exemplary embodiment, wherein the battery is flexible to conform with contortions of the main body.

According to another exemplary embodiment, a method of charging a wearable device through a supplemental charger capable of being combined with the wearable device, the method may include coupling the wearable device to the main body using coupling parts placed on the main body having both ends are extended in opposite directions and connected to each other, and charging the wearable device through a battery built in the main body when the wearable device is coupled to the main body.

The above-described exemplary embodiments are provided by way of illustration only and should not be construed as liming the present disclosure. Besides the above-described exemplary embodiments, there may be additional exemplary embodiments described in the accompanying drawings and the detailed description.

According to any one of the embodiments described or recited herein, a supplemental charger is coupled to, combined with, or otherwise attached to a wearable device to charge the wearable device while being worn by a user. Also, the supplemental charger may also be combined with various wearable devices, thus enable the wearable devices to be used longer.

### BRIEF DESCRIPTION OF THE DRAWINGS

FIG. 1A shows an example of a wearable device, in accordance with at least one embodiment described herein.

FIG. 1B shows a front view of a wearable device attached to the supplemental charger, in accordance with at least one embodiment described herein. FIG. 1C shows a partial bottom view of a wearable device attached to the supplemental charger, in accordance with at least one embodiment described herein.

FIG. 2A shows non-limiting top views of variations of the supplemental charger (a first shape), in accordance with at least some embodiments described herein.

FIG. 2B shows non-limiting top views of variations of an assist device (a second shape) for suppressing loss of function of the wearable device, in accordance with at least some embodiments described herein.

FIG. 3A is illustration provided to explain a front view of a process of combining the wearable device with the supplemental charger according to an embodiment of the present disclosure.

FIG. 3B is illustration provided to explain a front view of a process of combining the wearable device with the supplemental charger according to an embodiment of the present disclosure.

FIG. 3C is illustration provided to explain a partial bottom view of a process of combining the wearable device with the supplemental charger according to an embodiment of the present disclosure.

FIG. 3D is illustration provided to explain a partial side view of a process of combining the wearable device with the supplemental charger according to an embodiment of the present disclosure.

FIG. 4A is illustration provided to explain a front view of a process of combining the wearable device with the assist device for suppressing loss of function of the wearable device according to an embodiment of the present disclosure.

FIG. 4B is illustration provided to explain a front view of a process of combining the wearable device with the assist device for suppressing loss of function of the wearable device according to an embodiment of the present disclosure.

FIG. 4C is illustration provided to explain a partial bottom view of a process of combining the wearable device with the assist device for suppressing loss of function of the wearable device according to an embodiment of the present disclosure.

FIG. 5 is a flowchart showing a method of charging the wearable device through the supplemental charger which can be combined with the wearable device according to an embodiment of the present disclosure.

### DETAILED DESCRIPTION

Hereafter, example embodiments will be described in detail with reference to the accompanying drawings so that the present disclosure may be readily implemented by those skilled in the art. However, it is to be noted that the present disclosure is not limited to the example embodiments but can be embodied in various other ways. In the drawings, parts irrelevant to the description are omitted for the simplicity of explanation, and like reference numerals denote like parts through the whole document.

Throughout this document, the term “connected to” may be used to designate a connection or coupling of one element to another element and includes both an element being “directly connected” another element and an element being “electronically connected” to another element via another element. Further, it is to be understood that the term “comprises or includes” and/or “comprising or including” used in the document means that one or more other components, steps, operation and/or the existence or addition of elements are not excluded from the described components, steps, operation and/or elements unless context dictates otherwise; and is not intended to preclude the possibility that one or more other features, numbers, steps, operations, components, parts, or combinations thereof may exist or may be added.

Throughout this document, a “unit” may be implemented by hardware and/or software. As examples only, one unit may be implemented by two or more pieces of hardware or two or more units may be implemented by one piece of hardware.

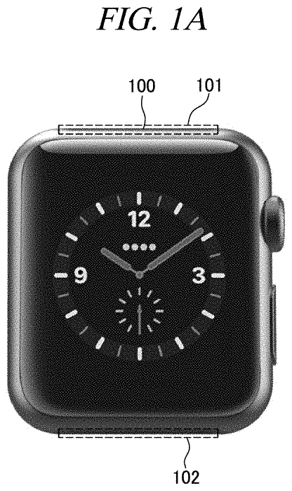

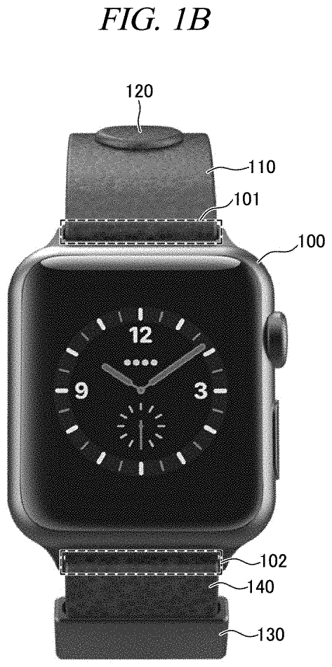

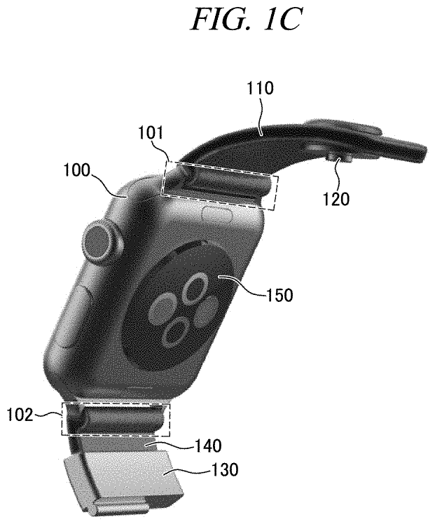

FIG. 1A shows an example of a wearable device, in accordance with at least one embodiment described herein. FIG. 1B shows a front view of a wearable device attached to the supplemental charger, in accordance with at least one embodiment described herein. FIG. 1C shows a partial bottom view of a wearable device attached to the supplemental charger, in accordance with at least one embodiment described herein. Referring to FIG. 1A to FIG. 1C, a wearable device 100 includes a pair of connection grooves (a first connection groove (101) and a second connection groove (102)) which are placed on both sides as spaced apart by a predetermined distance and correspond to each other.

A device-connecting end of first strap (or band) 110, which includes a first coupling assist part 120, may be slide into, or otherwise attach to, the first connection groove (101) formed on a first side of the wearable device 100; and a device-connecting end of second strap (or band) 140, which includes a second coupling assist part 130, may slide into, or otherwise attach to, the second connection groove (102) formed on a second, opposing side of the wearable device 100. The first side of the wearable device 100 may be fastened with first strap 110 and the second side of the wearable device 100 may be fastened with the second strap 140. For example, the first strap 110 including the first coupling assist part 120 and the second strap 140 including the second coupling assist part 130 are attachable to and detachable from the wearable device 100. The positions at which first strap 110 and second strap 140 may be fastened to wearable device 100 are changeable.

The wearable device 100 may include a display, a processor that controls functionality of the device including the display, a memory that stores data, and a power supply unit for at least the display. The wearable device 100 may further include a communication processor, which may or may not be processor that controls the display, that controls functionality including the transmission and reception of text messages, SMS messages, email, and/or telephone calls.

Wearable device 100 may further include therein a sensor 150 that senses biosignals of a user wearing the wearable device 100. For example, the wearable device 100 may include therein a pulse/heart rate sensor that measures the pulse/heart rate of the user, a temperature sensor that measures the user's body temperature, and the like. Thus, wearable device 100 may further function as a health monitoring device.

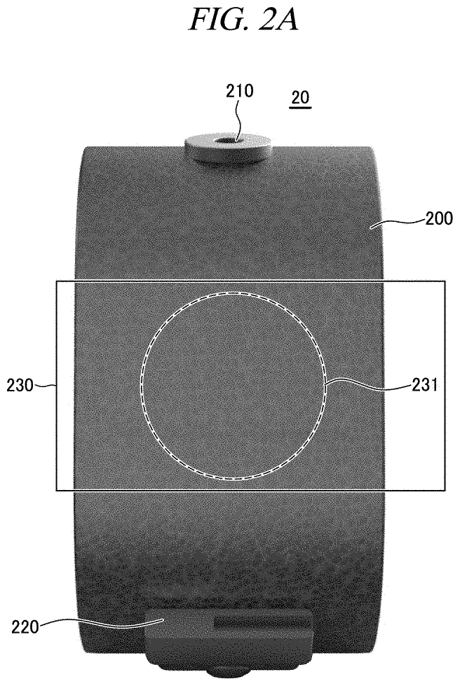

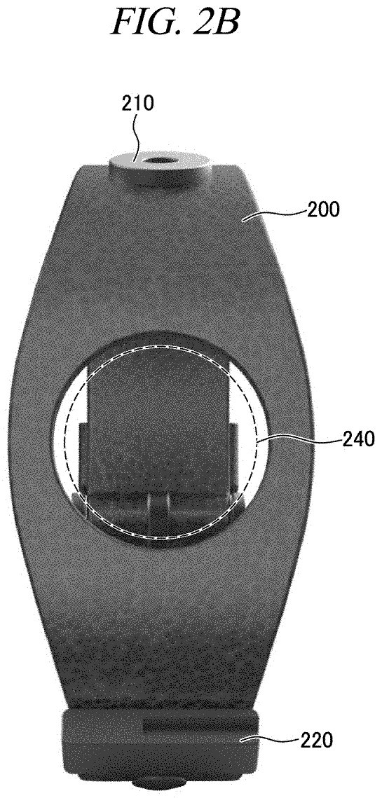

FIG. 2A shows non-limiting top views of variations of the supplemental charger (a first shape), in accordance with at least some embodiments described herein. FIG. 2B shows non-limiting top views of variations of the assist device (a second shape), in accordance with at least some embodiments described herein.

FIG. 2A and FIG. 2B are illustrations provided to explain a supplemental charger which can be combined with the wearable device 100 and an assist device for suppressing loss of function of the wearable device 100 according to an embodiment of the present disclosure. Referring to FIG. 2A, a supplemental charger 20, which may be combined, integrated, or otherwise affixed with the wearable device 100 may include a main body 200 having opposing ends that may extend in opposite directions, with distal ends thereof being configured to connect to each other; coupling parts 210 and 220, which may be attached or affixed on the main body 200, to couple with corresponding connectors on wearable device 100; and a charging unit 230 that charges the wearable device 100 when wearable device 100 is coupled to main body 200.

The main body 200 of supplemental charger 20 may be configured as a strap and thus may be wound around a user's wrist. Such configuration is not limiting. Further, main body 200 may be made of a flexible material that may flex under external pressure.

The main body 200 may include a strap including a fastener that connects the both ends of the main body 200. For example, the main body 200 may include a strap (e.g., a buckle-shaped strap) that connects the both ends of the main body 200 to each other by allowing a ring-shaped member provided on the end of one surface of the main body 200 to pass through one of multiple holes formed in the other surface of the main body 200 and fixing a fixing pin formed in the ring-shaped member to the hole. As another example, the main body 200 may include a strap that connects the both ends of the main body 200 to each other by allowing a fixing protrusion provided on the end of one surface of the main body 200 to pass through one of multiple holes formed in the other surface of the main body 200 and fixing the fixing protrusion to the hole.

Also, the main body 200 of the supplemental charger 20 may include various straps. For example, the main body 200 may include a strap with a line of a first shape to charge the wearable device 100 as shown in FIG. 2A. In the supplemental charger 20 with the line of the first shape, the main body 200 may be formed to have a uniform width and area. The main body 200 may include a strap with a line of a second shape in which a hole 240 is formed at the center of the main body 200 to use a sensor on a bottom surface of the wearable device 100 as shown in FIG. 2B. In the assist device with the line of the second shape, a central portion of the main body 200 may have a greater width and area than the other portion and the area of the main body 200 may increase gradually from the both ends toward the center.

Further, a strap cover covering the main body 200 of the supplemental charger 20 may be configured to cover a battery. For example, at least a part of the strap cover may be formed of various materials such as leather, polymer, rubber, fiber, silicon, urethane, steel, or the like.

The coupling parts 210 and 220 may have different shapes. Herein, the first coupling part 210 and the second coupling part 220 are formed as a pair at different locations on a top surface of the main body 200 and to enable wearable device 100 and main body 200 to attach to and detach from each other.

First coupling part 210 may couple to the first coupling assist part 120, which is connected to a first side of the wearable device 100, either magnetically or by sliding onto wearable device 100. Second coupling part 220 may couple to the second coupling assist part 130, which is connected to an opposing second side of the wearable device 100, either magnetically or by sliding onto wearable device 100. The magnetic and sliding coupling are provides as non-limiting examples. Other non-limiting examples for such coupling include hooking rings, interlocking studs, button fasteners, and screws, using various fastening components depending on a change in design and function of the coupling parts.

Referring to FIG. 1C together with FIG. 2A and FIG. 2B, first coupling part 210 may be coupled to the first coupling assist part 120 connected to the first side of the wearable device 100 and may affix the first side of the wearable device 100 to the main body 200. For example, if a magnet protrudes from the first side of the first coupling assist part 120 and a magnetic groove having a magnetic plate is formed inside the first coupling part 210, the magnet of the first coupling assist part 120 located on the magnetic groove of first coupling part 210 may be inserted into the magnetic groove to couple the first side of wearable device 100 to main body 200.

The second coupling part 220 may be coupled to the second coupling assist part 130 connected to the opposing, second side of wearable device 100 and may affix the other side of the wearable device 100 to the main body 200. For example, a protrusion formed on one side of the second coupling assist part 130 may be slidably inserted in a predetermined direction into a mounting space inside the second coupling part 220 and affix to main body 200.

As described above, the main body 200 of the wearable device 100 is fixed using a pair of coupling parts operating in different manners. Thus, for example, even if a magnetic type coupling part is detached from a coupling assist part of the wearable device 100, the other sliding type coupling part of the wearable device 100 can continuously affix the wearable device 100 and the main body 200. Therefore, according to the present disclosure, it is possible to more effectively fix the wearable device 100 to the main body 200 with a pair of coupling parts operating in different manners than with a pair of coupling parts operating in the same manner.

Referring to FIG. 2A again, the charging unit 230 is located at the center of the main body 200 and may include a charging area 231 at which the wearable device 100 may be charged. For example, charging area 231 may correspond to an area of the main body 200 where the wearable device 100 is located when the main body 200 is coupled to the wearable device 100. The charging area 231 faces the sensor located on the bottom surface of the wearable device 100 when the wearable device 100 is coupled to the main body 200. For example, the charging area 231 may face the sensor located on the bottom surface of the wearable device 100 in proximity within a predetermined distance or in contact with each other.

The charging unit 230 may wirelessly charge wearable device 100 coupled to the main body 200 at or near charging area 231. For example, the charging unit 230 may include a charging module (e.g., a Tx coil module) located under the charging area 231; and, thus, when the wearable device 100 is located to face the charging area 231, the charging unit 230 may wirelessly charge wearable device 100 by using the charging module. For example, the wearable device 100 can be wirelessly charged not only when it is in contact with the charging area 231, but also when it faces the charging area in proximity within a predetermined distance.

The charging unit 230 may include a battery built in the main body 200. The battery may be located on a bottom surface of the main body 200, opposite to charging area 231 and in parallel to an extension direction of the main body 200.

The battery built in the main body 200 may be a flexible battery that may be deformed in shape when the main body 200 is deformed. For example, when the user wears the main body 200, the battery built in the main body 200 may be deformed along the curve of the user's wrist. Since the flexible battery is built into the main body 200, the durability of the battery against external impact may be enhanced.

In the supplemental charger 20 including the strap with the line of the first shape, if the main body 200 has a shape as shown in FIG. 2A, the wearable device 100 coupled to the main body 200 can be wirelessly charged through the charging area 231 of the charging unit 230. However, in this case, it is difficult to measure biosignals of the user through the sensor located on the bottom surface of the wearable device 100.

A part of the main body 200 corresponding to the assist device including the strap with the line of the second shape may include a hole 240 through which the sensor 150 of the wearable device 100 can be brought into contact with the body of the user to suppress loss of function of the wearable device 100. In this case, the wearable device 100 cannot be charged through the charging unit 230 of the main body 200, but the sensor located on the bottom surface of the wearable device 100 is in contact with the body of the user, and, thus, it is possible to measure biosignals of the user through the sensor.

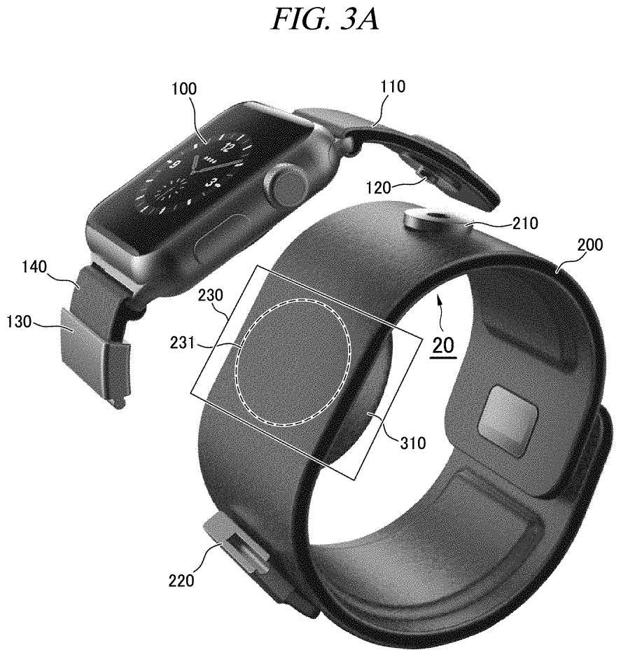

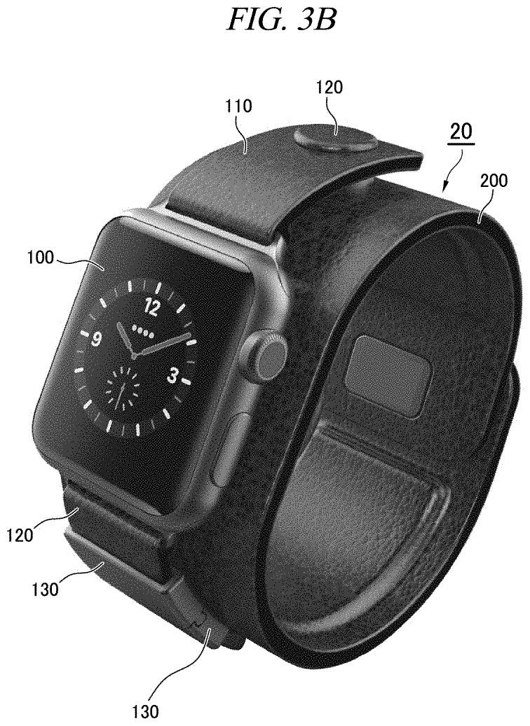

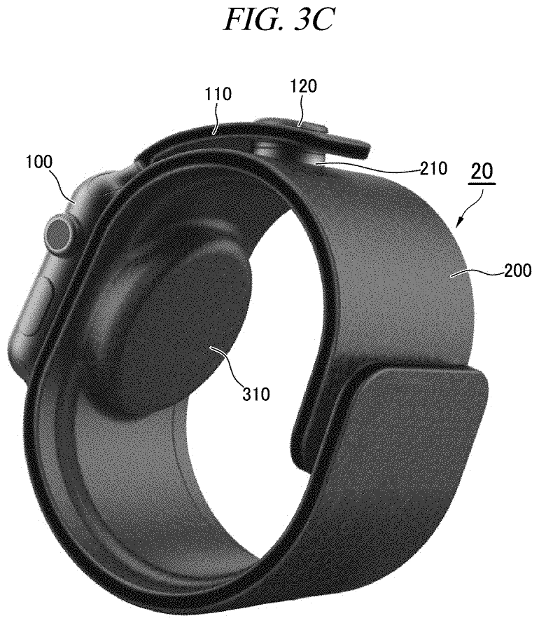

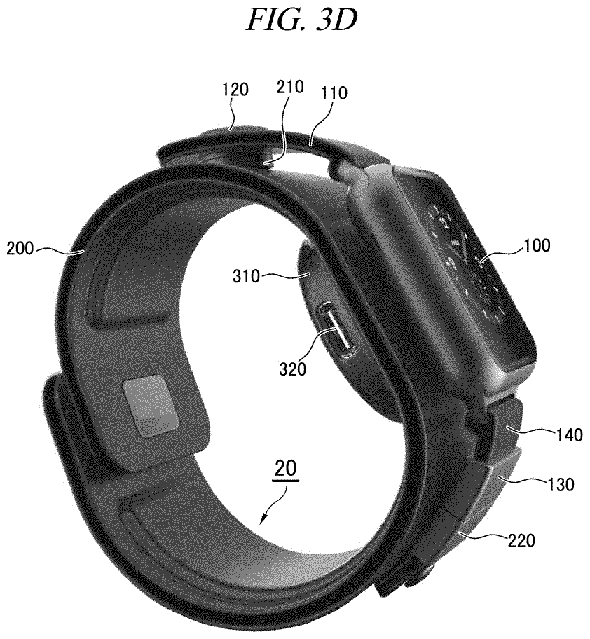

FIG. 3A to FIG. 3D are illustrations provided to explain a process of combining the wearable device 100 with the supplemental charger 20 according to an embodiment of the present disclosure.

Referring to FIG. 3A to FIG. 3D, the user may combine the wearable device 100 with the supplemental charger 20 including the strap with the line of the first shape and wear the combination on a wrist when charging wearable device 100. Specifically, the user may affix the first coupling assist part 120 connected to one side of the wearable device 100 magnetically first coupling part 210 provided in the main body of the supplemental charger 20; and slidably affix the second coupling assist part 130 connected to the other side of the wearable device 100 to the second coupling part 220 provided in the main body 200 of the supplemental charger 20. In this case, the sensor located on the bottom surface of the wearable device 100 may face the charging unit 230 including the charging area 231 of the supplemental charger 20.

The charging unit 230 may include the battery built into the main body 200 to charge the wearable device 100 and a charging module 310. When the wearable device 100 is coupled to the main body 200 and the sensor located on the bottom surface of the wearable device 100 faces the charging area 231, the wearable device 100 may be wirelessly charged through the battery and the charging module 310.

The charging unit 230 including the charging module 310 may include a connection port 320 that may be connected to an adapter or the like. Charging unit 230 charges the battery. The battery built in the main body 200 of the supplemental charger 20 can be charged by receiving external electricity through, e.g., the adapter connected to the connection port 320.

The user may connect the both ends of the main body 200 to each other by allowing the fixing protrusion provided on the end of one surface of the main body 200 to pass through one of multiple holes formed in an end portion of the other surface of the main body 200 and fixing the fixing protrusion to the hole.

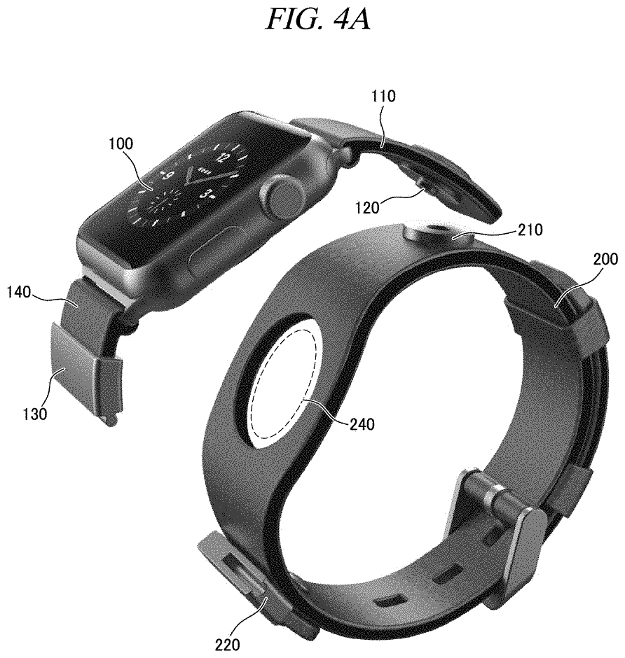

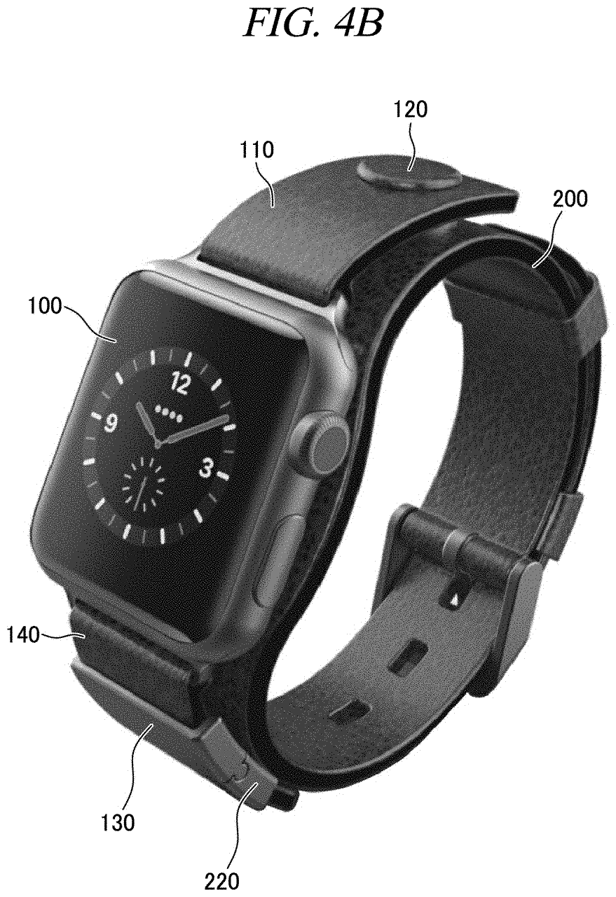

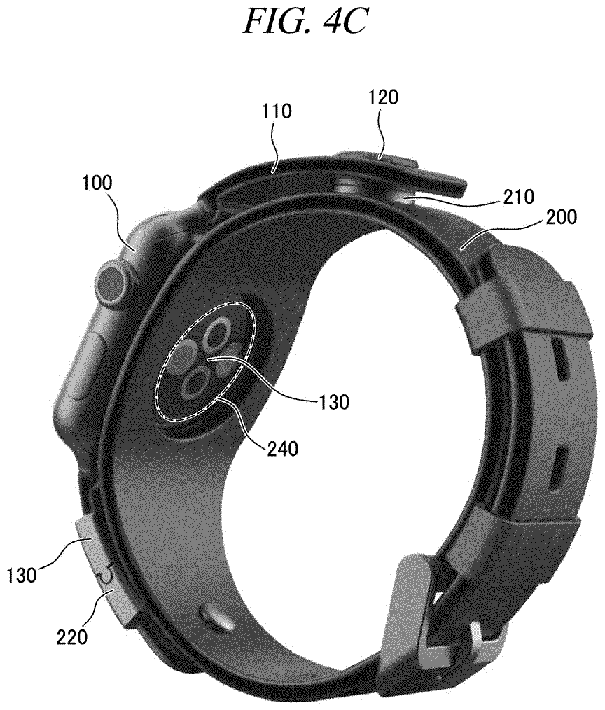

FIG. 4A to FIG. 4C are illustrations provided to explain a process of combining the wearable device with the assist device for suppressing loss of function of the wearable device according to an embodiment of the present disclosure.

Referring to FIG. 4A to FIG. 4C, the user may combine the wearable device 100 with the assist device including the strap with the line of the second shape and the hole 240 at the center of the main body 200 and wear the combination on the wrist in order to use the sensor on the bottom surface of the wearable device 100. Specifically, the user may magnetically affix the first coupling assist part 120 connected to one side of the wearable device 100 to the first coupling part 210 provided in the main body of the assist device, and slidably affix the second coupling assist part 130 connected to the other side of the wearable device 100i to the second coupling part 220 provided in the main body 200 of the assist device. For example, the hole 240 may be formed at the center of the main body 200 of the assist device, a central portion of the main body 200 may have a greater width and area than the other portion, and the area of the main body 200 may increase gradually from the both ends toward the center.

The assist device having a hole 240 at the center of the main body 200 may not have charging unit 230 shown in FIG. 2A and thus cannot charge the wearable device 100. However, the sensor 130 located on the bottom surface of the wearable device 100 may make contact with the user through the hole 240 of the assist device, and, thus measure biosignals of the user through the sensor 130 without loss of function of the wearable device 100.

The user may connect the both ends of the main body 200 to each other by allowing the ring-shaped member provided on the end of one surface of the main body 200 to pass through one of multiple holes formed in the other surface of the main body 200 and fixing a fixing pin formed in the ring-shaped member to the hole.

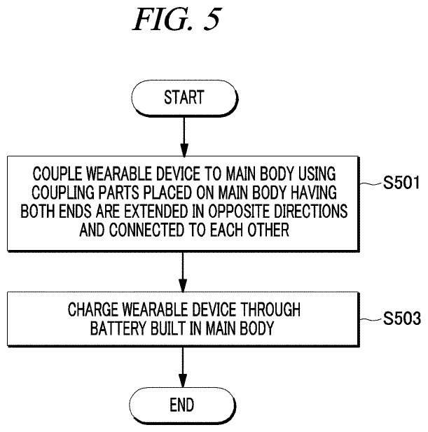

FIG. 5 is a flowchart showing a method of charging the wearable device 100 through the supplemental charger 20 which can be combined with the wearable device 100 according to an embodiment of the present disclosure.

Referring to FIG. 5, in process S501, the supplemental charger 20 may couple the wearable device 100 to the main body 200 using the coupling parts 210 and 220 placed on the main body 200 having both extendable ends in opposite directions and can be connected to each other.

In process S503, the supplemental charger 20 may charge the wearable device 100 through the battery built in the main body 200. Herein, the battery may be flexible to match a shape of the main body 200.

In the descriptions above, processes S501 and S503 may be divided into additional processes or combined into fewer processes depending on an exemplary embodiment. In addition, some of the processes may be omitted and the sequence of the processes may be changed if necessary.

The above description of the present disclosure is provided for the purpose of illustration, and it would be understood by those skilled in the art that various changes and modifications may be made without changing technical conception and essential features of the present disclosure. Thus, it is clear that the above-described embodiments are illustrative in all aspects and do not limit the present disclosure. For example, each component described to be of a single type can be implemented in a distributed manner. Likewise, components described to be distributed can be implemented in a combined manner.

The scope of the present disclosure is defined by the following claims rather than by the detailed description of the embodiment. It shall be understood that all modifications and embodiments conceived from the meaning and scope of the claims and their equivalents are included in the scope of the present disclosure.

We claim:

1. A supplemental charger capable of being combined with a wearable device, comprising:
a main body including:
a strap having opposing ends that are extendable in opposite directions and connectable to each other;
coupling parts configured to couple the wearable device to the main body, wherein at least one coupling part is attached to a respective one of the opposing ends of the strap; and
a charging unit to charge the wearable device when the wearable device is coupled to the main body, and
wherein the coupling parts include a first coupling part and a second coupling part,
the first coupling part is configured to connect to a first coupling assist part of a first strap connected to a first side of the wearable device, and
the second coupling part is configured to connect to a second coupling assist part of a second strap connected to an second side of the wearable device.

2. The supplemental charger of claim 1, wherein the strap is wound around a wrist of a user of the wearable device.

3. The supplemental charger of claim 1, wherein the coupling parts are configured to facilitate attachment and detachment of the wearable device and the main body.

4. The supplemental charger of claim 3, wherein first coupling part and the second coupling part are disposed separately on a top surface of the main body.

5. The supplemental charger of claim 4,
wherein the first coupling part connects to a first coupling assist part connected a first side of the wearable device to fix the first side of the wearable device to the main body, and
the second coupling part connects to a second coupling assist part connected a second side of the wearable device to fix the second side of the wearable device to the main body.

6. The supplemental charger of claim 5,
wherein the first coupling part connects magnetically to the first side of the wearable device or slides onto the first side of the wearable device, and
the second coupling part connects magnetically to the second side of the wearable device or slides onto the second side of the wearable device.

7. The supplemental charger of claim 1, wherein the charging unit includes a charging area on a top surface of the main body, on in which the wearable device is coupled to the main body.

8. The supplemental charger of claim 7, wherein the charging area faces a sensor on a bottom surface of the wearable device coupled to the main body.

9. The supplemental charger of claim 8, wherein the charging unit charges the wearable device coupled to the main body at the charging area.

10. The supplemental charger of claim 7, wherein the battery is disposed on an opposite side of the main body, relative to the charging area, integrated on to a bottom surface of the main body.

11. The supplemental charger of claim 10, wherein the battery is flexible to conform with contortions of the main body.

12. A method of charging a wearable device through a supplemental charger capable of being combined with the wearable device, the method comprising:
coupling the wearable device to the main body using coupling parts placed on the main body including a strap having opposing ends that are extendable in opposite directions and connectable to each other; and
charging the wearable device through a battery built in the main body when the wearable device is coupled to the main body, and
wherein the coupling parts include a first coupling part and a second coupling part, and
the method further comprising:
connecting the first coupling part to a first coupling assist part of a first strap connected to a first side of the wearable device, and
connecting the second coupling part to a second coupling assist part of a second strap connected to an second side of the wearable device.
